(19) United States
(12) Patent Application Publication
(10) Pub. No.: US 2012/0095911 A1
(43) Pub. Date: Apr. 19, 2012

(54) TRANSACTION SYSTEM AND METHOD

(75) Inventors: Alex D. Ibasco, Makati City (PH); Oliver L. Ubalde, Makati City (PH); Darlene Katherine L. Tiu, Makati City (PH); Rodrigo S. Salvador, Makati City (PH); Christopher R. Palermo, Makati City (PH)

(73) Assignee: SMART HUB PTE. LTD., Singapore (SG)

(21) Appl. No.: 13/377,364

(22) PCT Filed: Jun. 10, 2010
(86) PCT No.: PCT/SG10/00222

§ 371 Date: Dec. 9, 2011

(30) Foreign Application Priority Data
Jun. 16, 2009 (SG) 200904119-5

(51) Int. Cl. G06Q 40/00

(52) U.S. Cl. 705/39

(57) ABSTRACT

A transaction method and system comprising receiving a request to change a transaction channel or mode of an account having a plurality of transaction channels/modes from a first state to a second state; and changing the state of the transaction channel/mode to the second state in response to the received request is disclosed. The invention further discloses transaction facilitator for facilitating transactions in relation to an account having a plurality of transaction channels or modes, and operable to receive via the communication network a request from an owner of the account to change the state of a transaction channel/mode of the plurality of transaction channels/modes from a first state to a second state; wherein, upon receipt of the request the transaction facilitator is operable to change the state of the transaction channel to the second state.

### FIELD OF THE INVENTION

The present invention relates to a transaction system and method. The system and method are particularly relevant to facilitating secure Internet based mobile wallet financial transactions.

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

### BACKGROUND

Each document, reference, patent application or patent cited in this text is expressly incorporated herein in their entirety by reference, which means that it should be read and considered by the reader as part of this text. That the document, reference, patent application, or patent cited in this text is not repeated in this text is merely for reasons of conciseness.

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

People may fraudulently use a credit card linked to an account, or other account identification details, to illegally conduct transactions in respect of the account without authorisation from the legitimate account owner.

A prior art system has been disclosed that provides additional security by allowing a holder of a financial account card, such as a credit card or debit card, to disable and re-enable use of the card by locking and unlocking the card repeatedly.

This system adopts an “all or nothing” approach to the security problem, however, in that no transactions at all can be made when the associated card is in the locked state, and the holder has to unlock the card prior to making any transactions.

The present invention seeks, in one aspect, to provide a transaction system and method that reduces or prevents the occurrence of transaction fraud to at least some extent.

### SUMMARY

In accordance with an aspect of the present invention, there is provided a transaction method comprising: receiving a request to change a transaction channel or mode of an account having a plurality of transaction channels/modes from a first state to a second state; and changing the state of the transaction channel/mode to the second state in response to the received request.

Preferably, when in the first state, the transaction channel/mode is disabled or locked preventing transactions from being made in relation to the account via the transaction channel/mode, and when in the second state, the transaction channel/mode is enabled or unlocked, allowing transactions to be made in relation to the account via the transaction channel/mode.

Alternatively, the transaction channel/mode is enabled/unlocked when it is in the first state, and disabled/locked when it is in the second state.

Preferably, the request comprises a selection of the transaction channel/mode from the plurality of transaction channels/modes.

Preferably, the method further comprises returning the transaction channel/mode to the first state on satisfaction of a prescribed condition. The prescribed condition may comprise executing a transaction in relation to the account via the transaction channel/mode, and/or expiry of a period of time since changing the transaction channel to the second state.

Preferably, the change in state is automatically reverted to the first state within a preconfigured time delay or upon the transaction channel/mode being employed.

Preferably, the method further comprises receiving a transaction message in relation to the account, the transaction message comprising a request to execute a transaction in relation to the account via the transaction channel/mode; determining whether the transaction channel/mode is in the first state or the second state; and executing the requested transaction or an alternative action on the basis of the determined state. The alternative action may comprise denying the requested transaction.

Preferably, the transaction channel/mode is an on-line transaction via the Internet. Alternatively, the transaction channel/mode may be a debit, a savings/term deposit, a loan, a checking, a purchase, a transfer, and/or a withdrawal transaction.

Preferably, the account comprises at least one sub-account.

In accordance with another aspect of the present invention, there is provided a transaction system comprising: a communication network; and a transaction facilitator for facilitating transactions in relation to an account having a plurality of transaction channels or modes, and operable to receive via the communication network a request from an owner of the account to change the state of a transaction channel/mode of the plurality of transaction channels/modes from a first state to a second state; wherein, upon receipt of the request the transaction facilitator is operable to change the state of the transaction channel to the second state.

Preferably, when in the first state, the transaction channel/mode is disabled or locked preventing transactions from being made in relation to the account via the transaction channel/mode, and when in the second state, the transaction channel/mode is enabled or unlocked, allowing transactions to be made in relation to the account via the transaction channel/mode.

Alternatively, the transaction channel/mode is enabled/unlocked when it is in the first state, and disabled/locked when it is in the second state.

Preferably, the request comprises a selection of the transaction channel/mode from the plurality of transaction channels/modes.

Preferably, the transaction facilitator is operable to return the transaction channel/mode to the first state on satisfaction of a prescribed condition. The prescribed condition may comprise executing a transaction in relation to the account via the transaction channel/mode, and/or expiry of a period of time since changing the transaction channel/mode to the second state.

Preferably, the change in state is automatically reverted to the first state within a preconfigured time delay or upon the transaction channel/mode being employed.

Preferably, the transaction facilitator is operable to receive a transaction message in relation to the account, the transaction message comprising a request to execute a transaction in relation to the account via the transaction channel/mode, to determine whether the transaction channel/mode is in the first state or the second state, and to execute the requested transaction or an alternative action on the basis of the determined state. The alternative action may comprise denying the requested transaction.

Preferably, the transaction channel/mode is an on-line transaction via the Internet. Alternatively, the transaction channel/mode may be a debit, a savings/term deposit, a loan, a checking, a purchase, a transfer, and/or a withdrawal transaction.

Preferably, the account comprises at least one sub-account.

In accordance with still another aspect of the present invention, there is provided a transaction engine for use in a transaction system, the transaction engine being operable to: facilitate transactions in relation to an account having a plurality of transaction channels or modes; receive via a communication network a request from an owner of the account to change the state of a transaction channel/mode of the plurality of transaction channels/modes from a first state to a second state; and, upon receipt of the request, to change the state of the transaction channel to the second state.

Preferably, the account comprises at least one sub-account.

### BRIEF DESCRIPTION OF THE DRAWINGS

The present invention will now be described, by way of example only, with reference to the accompanying drawings, in which:

FIG. 1 is a schematic representation of an embodiment of a transaction system in accordance with an aspect of the present invention;

FIG. 2 is a sequence diagram of a Lock Internet Purchase request processed on the transaction system of FIG. 1;

FIG. 3 is a sequence diagram of an Off-Us Purchase via Internet transaction processed on the transaction system of FIG. 1; and

FIG. 4 is a schematic representation of another embodiment of a transaction system in accordance with an aspect of the present invention.

### DETAILED DESCRIPTION

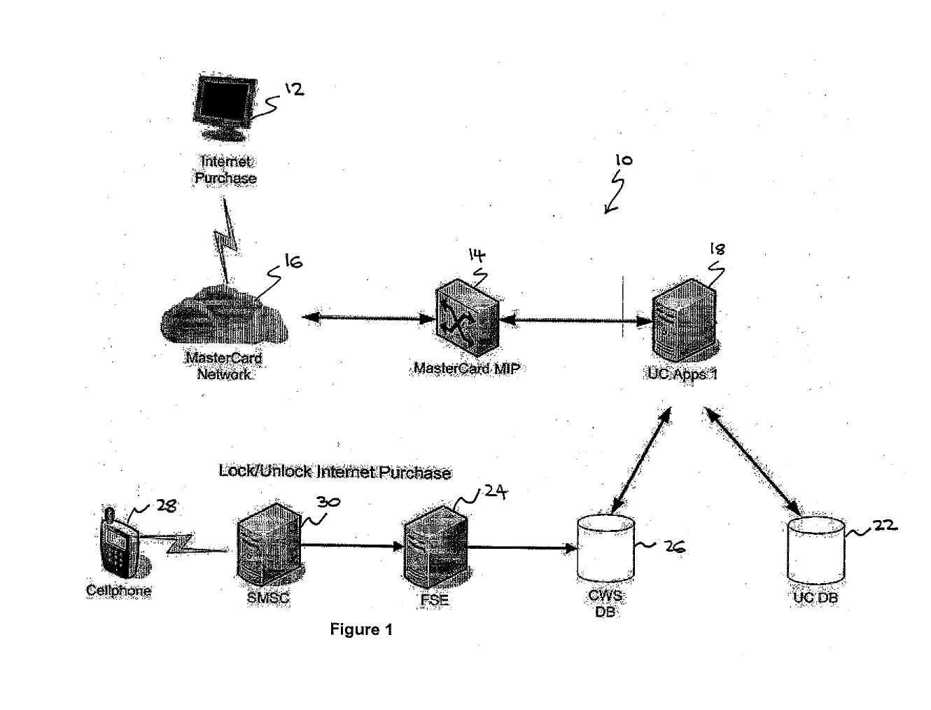

In FIG. 1, there is shown a first embodiment of a transaction system that comprises a first transaction means or device for generating a transaction message for transmission to a transaction facilitator. In the embodiment described, the first transaction means comprises a payment portal in the form of a website of a payment gateway of a merchant. The website is accessible by a user via a web browser of a personal computer 12 operably connected to be in data communication with other components of the transaction system 10 via a communication network. The means of data communication is through the Internet, however, other methods, such as direct connection, may be employed in other embodiments of the invention.

The merchant offers good and services for sale, which may be purchased on-line by a customer accessing the website.

The personal computer 12 is of standard configuration and includes display means in the form of a monitor or visual display, control means such as a keyboard and other suitable peripheral devices such as a mouse to enable a user to interact with the website and software applications.

The use and operation of the Internet, computers and servers using software applications and payment portals are well known to persons skilled in the art and need not be described in any further detail herein except as is relevant to the present invention.

In the embodiment described the transaction facilitator is MasterCard Worldwide. Alternative embodiments of the invention utilise other transaction facilitators, such as the American Express Company, or VISA Inc, for example. The use and operation of transactions facilitated by MasterCard Worldwide is well known to persons skilled in the art and need not be described in any further detail herein except as is relevant to the present invention.

The transaction system 10 also comprises a server having a MasterCard Interface Processor (“MIP”) 14 that interfaces with MasterCard's Global Payment System communications network 16 and is operable to facilitate data communication between the personal computer 12 and MasterCard Worldwide.

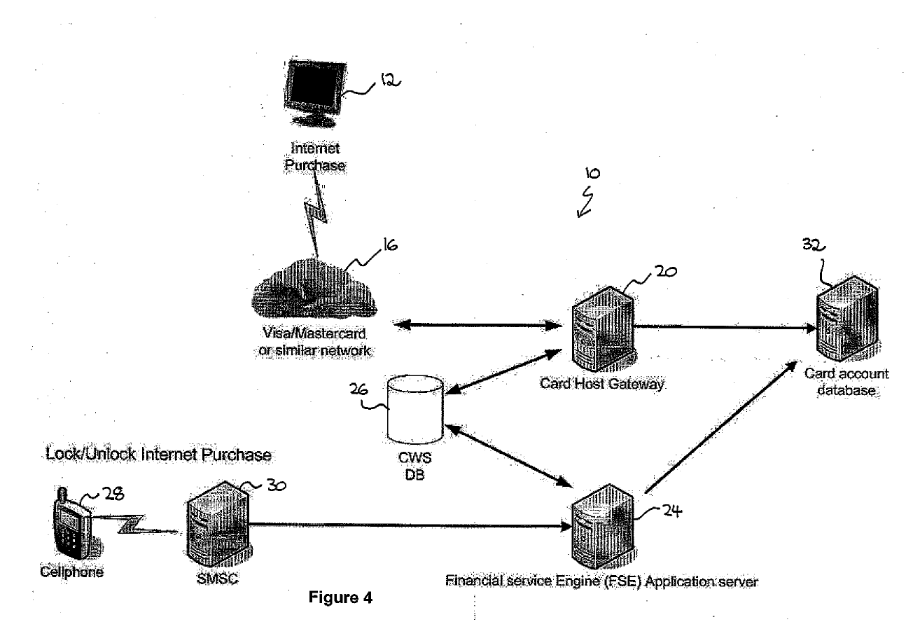

The MIP 14 also interfaces with a Unicard Gateway (“UC”) server 18 having a transaction computer software application (“transaction application”) stored and run thereon. The transaction application is operable to enable a number of functions to be performed as will be described in further detail below. In another embodiment of the invention the UC server 18 can be replaced with a Card Host Gateway (“CHG”) 20. This embodiment is illustrated in FIG. 4 of the drawings and described in further detail below following the description of the first embodiment of the invention.

In the first embodiment of the invention a UC database 22 is operably coupled to the UC server 18 and in data communication therewith in order to enable data to be read to and from the UC database 22.

The transaction system 10 additionally comprises a Financial Service Engine (“FSE”) 24 comprising a Customer Wallet Management System application (“CWS application”) stored and run thereon and operably coupled to a CWS database 26 in order to enable data to be read thereto and therefrom. The CWS application is operable to enable a number of functions to be performed as will be described in further detail below.

The UC server 18 is also operably connected to the FSE 24.

The transaction system 10 also comprises a second transaction means or communication device for generating a transaction message in the form of a Short Message Service (“SMS”) message, Multimedia Message Service (“MMS”) message, email message, etc, for example. In the embodiment described, this comprises a mobile or handheld radio telephone 28.

The operation and configuration of a cellular radio telephone is well known to persons skilled in the art and, as such, need not be described in any further detail herein, except as is relevant to the present invention.

The telephone 28 is used within a telecommunications network. The telecommunications network is owned and/or operated by a carrier. The telecommunications network facilitates communication between parties connected thereto, in a way that is well known to persons skilled in the art and, as such, need not be described in any further detail herein, except as is relevant to the present invention.

The telecommunications network includes all features of known cellular radio telephone networks—including a number of base stations and a network service centre or mobile switching centre. The mobile switching centre routes communications to the appropriate destination. The telecommunications network comprises a number of “cells”, not shown—each cell being served by a base station. Mobile stations, such as the telephone 28, can roam within the telecommunications network, and are in communication with the base station serving the cell in which they are located—provided that they are either in an active mode or a standby or “listening” mode. Thus, the mobile stations are able to send and receive signals to and from the base stations to transmit data—such as audio, control and text data—to the mobile switching centre, and from there to its intended recipient, such as other mobile stations, or servers such as Internet servers.

In the embodiment described, the telecommunications network is a Global System for Mobile Communication (“GSM”) network. GSM cellular radio telephone networks, the operation of such networks, and terminals using the networks are well known to persons skilled in the art, and therefore need not be described in any further detail herein, except in as is relevant to the present invention. Please note that the telecommunications network is not limited to being a GSM network, and alternative embodiments of the invention may use other communications protocols.

The carrier provides an SMS function on the telecommunications network, and, in this regard, the mobile switching centre interfaces with a short message service centre (“SMSC”) 30, that is operable to manage the SMS functions of the telecommunications network. In particular the SMSC 30 receives SMS messages from a variety of sources, identifies the sender, the content and the recipient for the message, and delivers it to that recipient.

A subscriber or user of the telecommunications network can send or receive text messages using the SMS function provided on the telecommunications network, for example using a mobile station such as the telephone 28, or using a computer coupled to an SMS gateway via the Internet, or any other suitable means.

The components of the transaction system 10 are provided with hardware and software to enable them to be operable to perform the described functions.

The above and other components of the transaction system 10 will now be described in further detail.

The telephone 28 is owned and operated by a customer or subscriber to a mobile phone wallet service facilitating the use of a virtual card account or electronic wallet linked to the number of the telephone 28 for financial transactions. In the embodiment described, this comprises the Smart Money™ service provided by Smart Communications, and described in the following Philippines Patent application: SMART Money (Application No. 1-2004-00286), Date Filed: Jul. 13, 2004, Title: Method and System for Macropayment and Micropayment Processing Using Cellphone-Linked Virtual Card Accounts. Alternative embodiments of the invention may use other mobile phone wallet or similar services provided by other service providers.

Throughout the specification the virtual card account or electronic wallet shall be referred to as Smart e-Money or simply e-Money. The subscriber is able to participate in mobile commerce transactions using e-Money without a physical card.

The emergence of mobile phone wallet services such as e-Money has resulted in many conveniences for end users. With a mobile phone wallet service it is possible for the end user to use their mobile phone for any number of financial transactions.

When the subscription to e-Money is initially activated (by, for example, the subscriber executing a software application from a relevant menu option provided on a Subscriber Identity Module (“SIM”) of a SIM Card of the telephone 28), an account for the subscriber is created from a pool of available (non-assigned) MasterCard card account numbers, assigned an e-Money Personal Identification Number (“M-PIN”) selected by the subscriber for additional security, and linked to the Mobile Subscriber Integrated Services Digital Network Number (“MSISDN”) and to the SIM Card of the telephone 28.

While in the described embodiment a MasterCard card number is linked to the account, in alternative embodiments of the invention any unique account identification may be linked to the account, such as from other types of credit cards or debit cards, for example.

The FSE 24 is operable to handle e-Money transactions of subscribers and, via the CWS application, is operable to handle the management and administration of subscriber records which are held in the CWS database 26. These functions include receiving and determining transaction requests, validating and processing transactions, and generating and sending notification messages to subscribers.

The CWS database 26 has a plurality of records. Each record comprises a set of account information relating to an account facilitated by the e-Money service provider (namely Smart Communications in the described embodiment) via the FSE 24.

The CWS database 26 contains subscriber information such as: the M-PIN associated with the account; the MasterCard account number; the MSISDN of the device linked to the account; an operational status of the account, such as active/live, inactive, etc; and a security status for the account. This specifies which of the transaction channels/modes available to the account are enabled, and will be described in further detail below.

In embodiments of the invention additional information can be stored, either in the CWS database 26 or another operably coupled database, including: a name of the account owner (the subscriber); an address of the account owner (the subscriber); a limit of the account; a present balance of the account; details of transactions conducted in respect of the account; an expiry date of the MasterCard card number linked to the account; an identifier(s) for communicating with the telephone 28 (and or any other device linked to the account or associated with the account owner) e.g. a telephone number, email address, etc; and types of transactions (transaction channels/modes) that may be conducted via the account (described in further detail below).

Any suitable database structure can be used, providing it enables the appropriate storage and query of the stored data.

These details are used to identify and communicate with the subscriber when transactions are being completed in respect of the account, and to facilitate such transactions.

One of the records in the CWS database 26 is for the owner of the telephone 28, and hereafter shall be referred to as the subscriber record. The subscriber record contains the relevant details for the subscriber and the telephone 28.

Having the e-Money account associated with a MasterCard card number is advantageous as it provides the subscriber with a number of transaction channels, types or modes to use—it further extends the potential utility of the mobile phone wallet service. In this regard, in addition to allowing the subscriber to participate in mobile commerce transactions using e-Money without a physical card as a first transaction channel/mode, it provides the subscriber with the option of engaging in on-line transactions via the Internet by submission of the relevant MasterCard card number and other details as a second transaction channel/mode. Furthermore, it allows a physical card associated with the account to be optionally created for use in traditional Point of Sale (“POS”), Automated Teller Machine (“ATM”) and similar transactions requiring a physical card as a third transaction channel/mode.

These benefits arise when the mobile phone account is tied up with any debit or credit card, not just ones provided by MasterCard Worldwide, with the user being able to exploit the associated debit/credit card credentials to use the mobile phone wallet to make purchases on the Internet that require debit/credit card credentials.

Credit cards and credit card facilities, POS systems, and ATM systems are well known to persons skilled in the art, and, as such, need not be described in any further detail herein, except as they are relevant to the present invention.

The degree of security associated with transactions made varies according to the channel/mode, with some being more secure than others.

In this regard, web-based or on-line transaction purchases are inherently less secure and more risky than POS based purchases or transactions. The described embodiment of the invention reduces this risk by allowing the subscriber to selectively choose when to activate or enable the second transaction channel (i.e. on-line transactions), whilst conveniently always maintaining the other (inherently more secure) transaction channels in an enabled state.

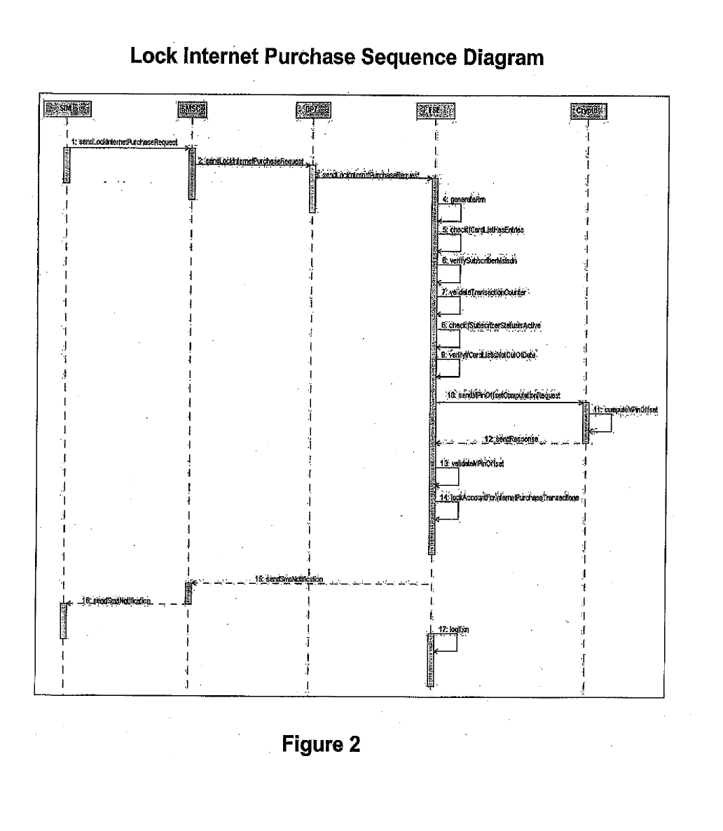

To disable the second channel/mode, and set it to a first state in which transactions are unable to be made using the subscriber's e-Money account via the Internet, the subscriber initiates a Lock Internet Purchase (“LIP”) request transaction. FIG. 2 of the drawings illustrates the operational sequence of the processing of such a request. The subscriber does this by executing a LIP software application provided on the SIM Application Toolkit (“SIM STK”) menu of the telephone 28 or via SMS to generate and send an electronic LIP request transaction message to the FSE 24 via the telephone 28 (via the SMSC 30 and an associated message Delivery Platform 7 (“DP7”)). The DP7 may be, but is not limited to a converter translating HTTP requests from the SIM menu for delivery to other systems.

The LIP request transaction message comprises information including a request to lock Internet purchasing for the subscriber's e-Money account, the M-PIN associated with the account, and the MSISDN of the telephone 28. In embodiments of the invention each possible transaction channel/mode facilitated has a separate security status, and the subscriber has the capability to lock/unlock the different channels/modes. In such embodiments the lock transaction message comprises a request to lock the particular transaction channel(s)/mode(s) that the subscriber wishes to deactivate.

Upon receipt of the LIP request transaction message, the FSE 24 is operable via the CWS application to access the subscriber record to: generate a Retrieval Reference Number (“RRN”), check if the subscriber has an e-Money account linked to his mobile number, verify the requester subscriber MSISDN, validate an associated transaction counter, confirm that the operational status of the subscriber's e-Money account is active, verify the card list is not out of date, and generate and send an M-PIN offset computation request to an encryption engine (“Crypto”). The Crypto secures generation, storage and use of cryptographic and sensitive data material such as the M-PIN. On receipt of the offset computation request Crypto computes an M-PIN offset and provides it to the FSE 24. The FSE 24 then validates the M-PIN offset by comparing if the offset stored in the CWS database 26 for the specified mobile number matches the computed offset provided by Crypto.

In regard to the Crypto capability, financial transactions require encryption due to their sensitive nature, particularly when such transactions are sent over the wire or from one system to another. Suitable Encryption techniques are well known to persons skilled in the art, and, as such, need not be described in any further detail herein, except as they are relevant to the present invention. There can be a number of variations to the encryption mechanism that can be employed, according to embodiments of the invention.

Once these prescribed conditions/requirements are verified and confirmed it is then operable to allow and process the request, and update the security status record entered for the subscriber record in the CWS database 26 to lock, disabling the account for Internet purchase transactions.

The FSE 24 is then operable to generate and send an electronic successful LIP notification message to the telephone 28 of the subscriber, via SMS via the SMSC 30, confirming that the request has been allowed (processed) and that the account has been locked for Internet purchase transactions (but that transactions via the other available channels/modes may still be made), and to log details of the transaction in the CWS database 26.

If the FSE 24 is unable to verify and confirm that all of the above mentioned criteria are satisfied, because, for example, it determines that the MSISDN does not exist, it is operable to deny the request, and to generate and send an electronic unsuccessful LIP notification message to the telephone 28 of the subscriber, via SMS via the SMSC 30, advising that the request has been denied (unprocessed) and the reason for the denial (including, for example, an error code and description of the reason(s) why the required condition(s) weren't satisfied), and to log details of the denied transaction in the CWS database 26.

To enable the second channel/mode, and set it to a second state in which transactions are able to be made using the e-Money account via the Internet, the subscriber initiates an Unlock Internet Purchase (“ULIP”) request transaction. The subscriber does this by executing a ULIP software application provided on the SIM STK menu of the telephone 28 or via SMS to generate and send an electronic ULIP request transaction message to the FSE 24 via the telephone 28 (via the SMSC 30 and DP7).

The ULIP request transaction message comprises information including a request to unlock Internet purchasing for the subscriber's e-Money account, the PIN associated with the account, and the MSISDN of the telephone.

As described previously, in some embodiments of the invention each possible transaction channel/mode facilitated has a separate security status, and the subscriber has the capability to lock/unlock the different channels/modes. In such embodiments the unlock transaction message comprises a request to unlock the particular transaction channel(s)/mode(s) that the subscriber wishes to activate.

Upon receipt of the ULIP request transaction message, the FSE 24 is operable via the CWS application to access the subscriber record to ensure that the same conditions as in the LIP request procedure described above are satisfied and to additionally confirm that the security status of the subscriber's e-Money account is locked. Once these conditions are verified and confirmed it is then operable to allow and process the request, and update the security status recorded in the subscriber record in the CWS database 26 to unlock, enabling the account for Internet purchase transactions.

The FSE 24 is then operable to generate and send an electronic successful ULIP notification message to the telephone 28 of the subscriber, via SMS via the SMSC 30, confirming that the request has been allowed (processed) and that the account has been unlocked for Internet purchase transactions (and so transactions may be made by any of the channels/modes), and to log details of the transaction in the CWS database 26.

If the FSE 24 is unable to verify and confirm that all of the above mentioned conditions are satisfied, because, for example, it determines that the MSISDN does not exist, it is operable to deny the request, generating and sending an electronic unsuccessful ULIP notification message to the telephone 28 of the subscriber, via SMS via the SMSC 30, advising that the request has been denied (unprocessed), and the reason for the denial (including, for example, an error code and description of the reason(s) why the required condition(s) weren't satisfied), and to log details of the denied transaction in the CWS database 26.

In further embodiments of the invention, alternative methods of notification may also be employed.

In the described embodiment of the invention, the default condition or security status of the subscriber's e-Money account in regard to on-line transactions is the first state—locked. It is advantageous for this transaction channel/mode to be locked or disabled except for when the subscriber wishes to use it, so as to prevent another person from illegally using the subscriber's MasterCard card number and other details to make on-line transactions. To enable the on-line purchasing service facilitated by the second channel, the subscriber needs to explicitly unlock the web based purchase feature of the transaction system 10 using their telephone 28.

The security provided is further enhanced by the CWS application being operable to return the security status entered for the subscriber record in the CWS database 26 to the default locked condition, i.e. automatically relock (“auto-lock”) the service, after an on-line transaction such as web purchase is made (as described in further detail below), or automatically after a prescribed, configurable period of time, for example 30 minutes, has elapsed since the service was unlocked if no on-line transaction has been conducted.

A subscriber may choose not to have this feature implemented in respect of their account, in which case, the FSE 24 is operable to generate an indicator in the form of a flag in the relevant subscriber record, showing that automatic locking for Internet transactions has not been enabled in respect of that account.

As described above, in the embodiment described, only the second transaction channel or mode can be locked/unlocked. The first and third transaction channels are always available for use by the subscriber to conduct transactions. In this way, the embodiment of the invention provides for selective channelized lock/unlock and transactional lock/unlock. Alternative embodiments of the invention allow for other of the possible transaction channels, such as POS and ATM, for example, to be selectively locked (disabled)/unlocked (enabled).

To conduct an on-line transaction using their e-Money account, the subscriber firstly unlocks the second transaction channel by executing a successful ULIP request transaction as described above. This is required because, in the embodiment described, the second transaction channel is locked or disabled by default The subscriber then accesses the merchant's website using the personal computer 12, selects from the goods and services available those that they wish to purchase, and enters the MasterCard card number and other relevant details of their account as required by the payment gateway to initiate the transaction. An electronic transaction request message comprising transaction information including details of the selected goods/services, the amount charged, the MasterCard card number and the other relevant details of their account is generated and relayed through the communication network.

The transaction message is received by the MIP 14 and forwarded to the UC server 18 for processing.

Upon receipt of the transaction message, the UC server 18 is operable via the transaction application to distinguish if the purchase transaction of the transaction message is via the Internet. There is an additional field (POS entry mode) in the request that the UC server 18 uses to be able to distinguish if transaction is via the Internet. If the US server 18 determines that it is an Internet transaction it is operable to add additional information thereto (such as POS entry mode, or a processing code, for example) to identify that it is such a transaction, thereby generating an on-line identified transaction request message.

The transaction application is then operable to log details of the on-line identified transaction request message in the UC database 22, and to forward the on-line identified transaction request message to the FSE 24 which is operable to parse and process the information contained therein.

In particular, the FSE 24 is operable to process the additional information included in the on-line identified transaction message to identify that the transaction message is an Internet transaction type (and not another type of transaction) and, if so, to validate that the security status of the relevant subscriber record in the CWS database 26 should be checked to ensure that the Internet purchase transaction channel has been unlocked (enabled) before allowing the transaction to proceed.

Once it has identified that it is an Internet transaction type, the FSE 24 is operable, via the CWS application, to query the CWS database 26 to: validate if the security status (account Internet lock status) of the account of the subscriber record is unlocked (enabled); check or confirm that the subscriber account exists and locate the subscriber account (by comparing the MasterCard card number account details contained in the on-line identified transaction message with the MasterCard card number account details held in the CWS database 26); validate if the operational status of the account of the subscriber record is active/live; verify if the transaction limit of the account of the subscriber record would be exceeded by the transaction; and verify if the present balance/credit of the account of the subscriber record is sufficient to accommodate the transaction.\

If all of these requirements are satisfied, the FSE 24 is operable, via the CWS application, to allow the transaction, debit the subscriber account, log the transaction details, and update the subscriber record accordingly.

The FSE 24 is then operable to generate and send an electronic successful response (transaction granted—successful purchase) transaction notification message to the UC server 18, confirming that the transaction requested in the transaction message has been allowed (processed) and the details thereof. The UC server 18 then forwards the transaction granted message to relevant parties in the transaction via the communication network, including MasterCard Worldwide via the MIP 14 and the MasterCard network 16, and the MSP server 20.

The FSE 24 is further operable to generate and send an electronic successful response (transaction granted—successful purchase) transaction notification message to the telephone 28 of the subscriber, via SMS via the SMSC 30, confirming that the transaction requested in the transaction message has been allowed (processed) and the details thereof.

Once the on-line transaction is completed, the FSE 24, via the CWS application, operates to return the security status entered for the subscriber record in the CWS database 26 to the default locked condition, i.e. relock the service. In the event that the subscriber did not conduct such a transaction within 30 minutes of unlocking the service, the FSE 24 would take such action automatically on expiry of this time period.

If the FSE 24 is unable to verify and confirm the above mentioned conditions, because, for example, the security status (account Internet lock status) of the account of the subscriber record is locked, it is operable, via the CWS application to deny or decline the transaction, and to generate and send an electronic unsuccessful response (transaction declined—unsuccessful purchase) transaction notification message to the UC server 18, advising that the transaction requested in the transaction message has been declined (unprocessed) and the details thereof (including, for example, an error code and description of the reason(s) why the required condition(s) weren't satisfied). The UC server 18 then forwards the transaction declined message to relevant parties in the transaction via the communication network, including MasterCard Worldwide via the MIP 14 and the MasterCard network 16.

The FSE 24 is further operable to generate and send an electronic unsuccessful response (transaction declined—unsuccessful purchase) transaction notification message to the telephone 28 of the subscriber, via SMS via the SMSC 30, advising that the transaction requested in the transaction message has been declined (unprocessed) and the details thereof, and to log details of the denied transaction in the CWS database 26.

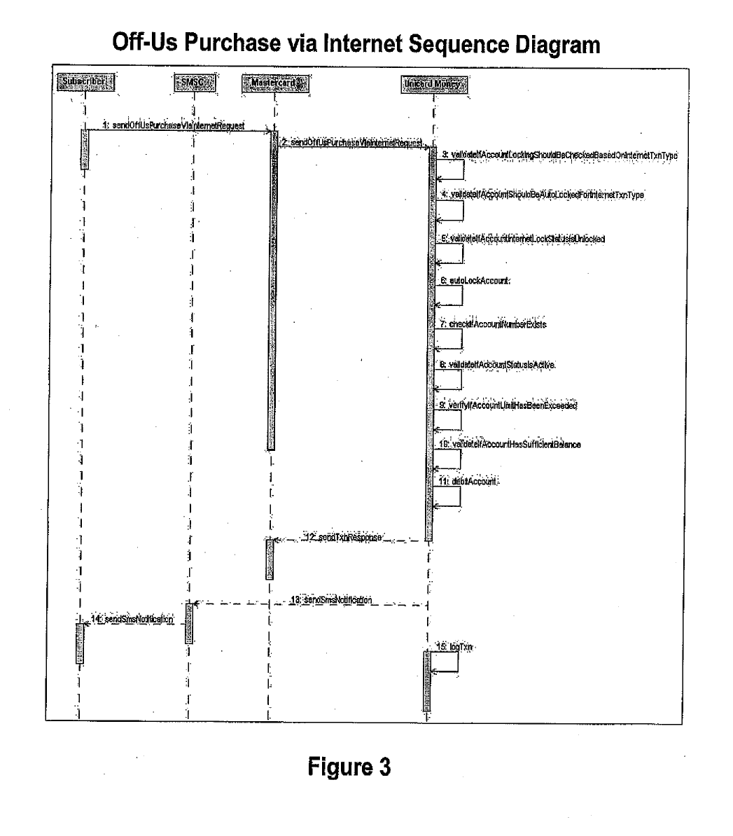

In another embodiment of the transaction system 10, the UC server 18 is further operable to process e-Money transactions and hold balances of subscribers' e-Money accounts (Refer to functions under ‘Unicard Money’). FIG. 3 of the drawings illustrates the steps involved in a subscriber conducting an off-us purchase via Internet transaction using the transaction system 10 of such an embodiment.

In this embodiment, once the UC server 18 has identified that the transaction message is an Internet transaction type (and not another type of transaction) it is operable to validate that the security status of the relevant subscriber record in the CWS database 26 should be checked to ensure that the Internet purchase transaction channel/mode has been unlocked (enabled) before allowing the transaction to proceed.

Once this has been done, the UC server 18 is operable, via the transaction application, to query the CWS database 26 to: validate if the security status (account Internet lock status) of the account of the subscriber record should be auto-locked for Internet transaction type; validate if the security status (account Internet lock status) of the account of the subscriber record is unlocked (enabled), and then automatically change this to locked once satisfied that it should be auto-locked after receipt of a transaction request; check or confirm that the subscriber account exists and locate the subscriber account (by comparing the MasterCard card number account details contained in the on-line identified transaction message with the MasterCard card number account details held in the CWS database 26); validate if the operational status of the account of the subscriber record is active/live; verify if the transaction limit of the account of the subscriber record would be exceeded by the transaction; and verify if the present balance/credit of the account of the subscriber record is sufficient to accommodate the transaction.

If all of these requirements are satisfied, the UC server 18 is operable, via the transaction application, to allow the transaction, debit the subscriber account, log the transaction details, and update the subscriber record accordingly. If the UC server 18 determines that account locking for the Internet transaction type should not be checked before allowing the transaction to proceed, all of the above requirements need to be satisfied for the transaction to proceed, with the exception of those relating to the security status (account Internet lock status) of the account of the subscriber record.

The UC server 18 is then operable to generate and send an electronic successful response (transaction granted—successful purchase) transaction notification message, confirming that the transaction requested in the transaction message has been allowed (processed) and the details thereof, to relevant parties in the transaction via the communication network, including MasterCard Worldwide via the MIP 14 and the MasterCard network 16.

The UC server 18 is further operable to generate and send an electronic successful response (transaction granted—successful purchase) transaction notification message to the telephone 28 of the subscriber, via SMS via the SMSC 30, confirming that the transaction requested in the transaction message has been allowed (processed) and the details thereof.

Once the on-line transaction is completed, the UC server 18, via the transaction application, operates to return the security status entered for the subscriber record in the CWS database 26 to the default locked condition, i.e. relock the service, if it should be auto-locked. In the event that the subscriber did not conduct such a transaction within 30 minutes of unlocking the service, such action would be taken automatically on expiry of this time period.

If the UC server 18 is unable to verify and confirm the above mentioned conditions, because, for example, the security status (account Internet lock status) of the account of the subscriber record is locked, it is operable, via the transaction application to deny or decline the transaction, and to generate and send an electronic unsuccessful response (transaction declined—unsuccessful purchase) transaction notification message, to relevant parties in the transaction via the communication network, advising that the transaction requested in the transaction message has been declined (unprocessed) and the details thereof (including, for example, an error code and description of the reason(s) why the required condition(s) weren't satisfied). The relevant parties include MasterCard Worldwide via the MIP 14 and the MasterCard network 16.

The UC server 18 is further operable to generate and send an electronic unsuccessful response (transaction declined—unsuccessful purchase) transaction notification message to the telephone 28 of the subscriber, via SMS via the SMSC 30, advising that the transaction requested in the transaction message has been declined (unprocessed) and the details thereof, and to log details of the denied transaction in the CWS database 26.

As described above, in another embodiment of the invention, illustrated in FIG. 4 of the drawings, the UC server 18 is replaced with a Card Host Gateway (“CHG”) 20. The CHG 20 is operably coupled to a Card Account (“CA”) database 32, rather than the UC database 22, and is in data communication therewith in order to enable data to be read thereto and therefrom. The FSE 24 is similarly in data communication with the CA database 32.

The CA database 32 is operable to store pertinent information for subscriber accounts and to facilitate logging of details of transactions therein by the CHG 20 and FSE 24.

The Card Host gateway 20 is operable to perform the functions of the UC server 18 as hereinbefore described.

Embodiments of the invention provide a solution to mitigate potential fraud and provide enhanced security, as the only window of opportunity provided for an unauthorized person to fraudulently use the MasterCard card number details of the subscriber's account in an on-line financial transaction lies in the period between the subscriber unlocking the second transaction channel of the account and making an on-line transaction or expiry of the 30 minute period for doing so, after which the account is locked (disabled) for such transactions as described previously.

Most fraud prevention/security measures for transaction systems have been focused towards the front-end or the point of sale/transaction side of the transaction. In the embodiment described, the security measure is applied to the back-end of the transaction, at the FSE 24. This advantageously provides an additional layer of security protection, as it provides a security layer that is more difficult to reach for fraudsters, and hence more difficult to compromise, because it is placed in the back-end.

Importantly, the enhanced security is provided in respect of the second transaction channel, that is inherently less secure than the other transaction channels available to the subscriber via their account, and which the subscriber can conveniently continue using without requiring any action to be taken (to unlock/enable them) beforehand.

It should be appreciated by the person skilled in the art that the invention is not limited to the embodiments described. For example, the invention as described can include the following modifications and/or additions: Channel mode based lock/unlock—any account transaction channel may be selectively locked (disabled)/unlocked (enabled), for any type of financial account, including credit, debit, savings/term deposit, loan, and checking, for example; Each account associated with a transaction channel may further include sub-accounts; each of the sub-accounts may be selectively locked (disabled)/unlocked (enabled) for any type of financial account, including credit, debit, savings/term deposit, loan, and checking, for example; Locking/Unlocking of the accounts or features may be performed via SMS, via the web, by phone, and WAP, for example; Transaction mode based lock/unlock—any transaction type for an account may be selectively locked (disabled)/unlocked (enabled), including transactions such as purchases, transfers, and withdrawals, for example; Alert identification means in the form of a flag, for example, in the transaction system to allow for accounts where account locking (for Internet transactions, for example) is not checked/applied; and Embodiments of the invention may be employed with any number of other security functions that may be enabled on the mobile phone device or on the network for securing financial transactions.

It should be further appreciated by the person skilled in the art that variations and combinations of features described above, not being alternatives or substitutes, can be combined to form yet further embodiments falling within the intended scope of the invention. 1.

What is claimed is:

1-27. (canceled)

28. A transaction method comprising:
receiving a request to change at least one transaction channel or mode of an account associated with a unique identifier of a communications device from which the request has been received from a first state to a second state; and
changing the state of the at least one transaction channel or mode to the second state in response to the received request,
where, a subsequent transaction message identified with a transaction channel or mode set to the first state is refused and where a subsequent transaction message identified with a transaction channel or mode set to the second state is passed on for further transactional processing.

29. A transaction method according to claim 28, further comprising the step of automatically changing the state of at least one of the at least one transaction channel or mode to the first state on elapsing of a predetermined amount of time.

30. A transaction method according to claim 29, where the predetermined amount of time is calculated from one of the following actions: the receipt of the request to change the transaction channel or mode from the first state to the second state; or the receipt of the last transaction message identified with the relevant transaction channel or mode.

31. A transaction method according to claim 28, further comprising the step of automatically changing the state of at least one of the at least one transaction channel or mode to the first state following receipt of a subsequent transaction message identified with that transaction channel or mode.

32. A transaction method according to claim 28, further comprising the step of sending to the communications device a status message indicating the current state of at least one of the at least one transaction channel or mode.

33. A transaction method comprising:
receiving a request to change at least one account from a first state to a second state and/or receiving a request to change at least one transaction type associated with at least one transaction channel or mode of at least one account from a first state to a second state; and
changing the state of the transaction type or account, as appropriate, to the second state in response to the received request,
where, a subsequent transaction message identified with the at least one transaction channel is refused except where the transaction message is identified with a transaction channel or mode set to the second state and is in relation to one of the at least one accounts and one of the at least one transaction types each of which is also set to the second state.

34. A transaction method according to claim 33, further comprising the step of sending to a communications device a status message indicating the current state of at least one of the following: at least one transaction channel or mode; at least one account; and/or at least one transaction type.

35. A transaction engine for use in a transaction system, the transaction engine operable to:
receive a request to change at least one transaction channel or mode of an account associated with a unique identifier of a communications device from which the request has been received from a first state to a second state; and
change the state of the at least one transaction channel or mode to the second state in response to the received request;
where, a subsequent transaction message identified with a transaction channel or mode set to the first state is refused and where a subsequent transaction method identified with a transaction channel or mode set to the second state are passed on for further transactional processing.

36. A transaction engine according to claim 35, further operable to automatically change the state of at least one of the at least one transaction channel or mode to the first state on elapsing of a predetermined amount of time.

37. A transaction engine according to claim 36, where the predetermined amount of time is calculated from one of the following actions: the receipt of the request to change the transaction channel or mode from the first state to the second state; or the receipt of the last transaction message identified with the relevant transaction channel or mode.

38. A transaction engine according to claim 35, further operable to automatically change the state of at least one of the at least one transaction channel or mode to the first state following receipt of a subsequent transaction message identified with that transaction channel or mode.

39. A transaction engine according to claim 35, where at least one of the at least one transaction channel or mode represents Internet-originating transactions.

40. A transaction engine according to claim 35, further operable to send to the communication device a status message indicating the current state of at least one of the at least one transaction channel or mode.

41. A transaction engine for use in a transaction system, the transaction engine operable to:
receive a request to change at least one account from a first state to a second state and/or receive a request to change at least one transaction type associated with at least one transaction channel or mode of at least one account from a first state to a second state; and change the state of the transaction type or account, as appropriate, to the second state in response to the received request,
where, a subsequent transaction message identified with at least one transaction channel is refused except where the transaction message is identified with a transaction channel or mode set to the second state and is in relation to one of the at least one accounts and one of the at least one transaction types each of which is also set to the second state.

42. A transaction engine according to claim 41, further operable to send to a communications device a status message indicating the current state of at least one of the following: at least one transaction channel or mode; at least one account; and/or at least one transaction type.

43. A communications device for communicating with a transaction engine, wherein the communications device has a unique identifier and is associated with an account having at least one transaction channel or mode of transaction processing, the communications device operable to send a request to change at least one of the transaction channel or mode of the account from a first state to a second state, where a subsequent transaction message identified with a transaction channel or mode set to the first state is refused and where a subsequent transaction message identified with a transaction channel or mode set to the second state is passed on for further transactional processing.

44. A communication device according to claim 43, where the communications device is a mobile phone.

45. A communications device according to claim 43, where at least one of the at least one transaction channel or mode of transaction processing represents Internet-originating transactions.

46. A computer program stored on recordable media that, on execution of the program by suitable processing means is operable to:
receive a request to change at least one transaction channel or mode of an account associated with a unique identifier of a communications device from which the request has been received from a first state to a second state; and
changing the state of the at least one transaction channel or mode to the second state in response to the received request,
where, a subsequent transaction message identified with a transaction channel or mode set to the first state are refused and where a subsequent transaction message identified with a transaction channel or mode set to the second state are passed on for further transactional processing.

47. A computer program stored on recordable media that, on execution of the program by suitable processing means is operable to:
receive a request to change at least one account from a first state to a second state and/or receive a request to change at least one transaction type associated with at least one transaction channel or mode of at least one account from a first state to a second state; and
change the state of the transaction type or account, as appropriate, to the second state in response to the received request,
where, a subsequent transaction message identified with the at least one transaction channel is refused except where the transaction message is identified with a transaction channel or mode set to the second state and is in relation to one of the at least one accounts and one of the at least one transaction types each of which is also set to the second state.

48. A transaction system comprising:
a plurality of transaction channels or modes associated with a transaction account; where at least one transaction channel or mode is unsecured relative to other transaction channels or modes; and
a transaction engine adapted to receive a request from the transaction account holder based on a unique identifier of the account holder to change the state of the relatively unsecured channel or mode from a first state to a second state in response to the received request;
wherein a subsequent transaction message identified with the relatively unsecured transaction channel or mode set to the first state is refused and where a subsequent transaction message identified with the relatively unsecured transaction channel or mode set to the second state is passed on for further transactional processing.

49. The transaction system according to claim 48, wherein the relatively unsecured transaction channel or mode is an Internet-originating transaction or mode.

50. The transaction system according to claim 48, wherein the plurality of transaction channels or modes include POS and ATM.

51. The transaction system according to claim 48, wherein the transaction engine is arranged with an encryption engine to authenticate the request from the account holder to determine whether to proceed with the change from first state to second state.

52. A transaction method comprising:
receiving a request to change a relatively unsecured transaction channel or mode of a plurality of transaction channels or modes, the request associated with a unique identifier of a communications device from which the request has been received from a first state to a second state; and
changing the state of the relatively unsecured transaction channel or mode to the second state in response to the received request.
where a subsequent transaction message identified with the relatively unsecured transaction channel or mode set to the first state is refused and where a subsequent transaction message identified with the relatively unsecured transaction channel or mode set to the second state is passed on for further transactional processing.

53. The transaction method according to claim 52, wherein the relatively unsecured transaction channel or mode is an Internet-originating transaction channel or mode.

54. The transaction method according to claim 52, wherein the plurality of transaction channels or modes include POS and ATM.
